(19) United States
(12) Patent Application Publication
(10) Pub. No.: US 2005/0144263 A1
(43) Pub. Date: Jun. 30, 2005

(54) Server, data processing system, and method of data processing

(76) Inventor: Masayuki Shiba, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/005,005

(22) Filed: Dec. 7, 2004

(30) Foreign Application Priority Data
Dec. 15, 2003 (JP) 2003-416220

(51) Int. Cl. G06F 15/177

(52) U.S. Cl. 709/221

(57) ABSTRACT

A server according to this invention comprises an execution processing unit for receiving access of a plurality of client terminal devices and executing processes according to a command given by the client terminal devices, an acquiring unit for acquiring an access status data representing information showing access status of the client terminal devices in the execution processing unit, a determining unit for determining whether the access status data satisfies a predetermined condition, and an output unit for producing an output of data based on the access status data when the determining unit determines that the access status data satisfies the predetermined condition. A structure discussed above can provide the server with a capability of outputting data on the access status thereof only when output of the data is needed.

### TECHNICAL FIELD

The present invention relates to a server and the like device for receiving access from a plurality of client terminal devices.

### BACKGROUND OF THE INVENTION

There have been hitherto developed certain systems that automatically measure a degree of congestion in client receiving windows such as a call center, and make them available through the network, as has been disclosed in Japanese Patent Unexamined Publication, No. 2002-368897 (page 7 through page 9, and FIG. 1, etc.).

On the other hand, it is considered in many cases that users become accustomed to display of access status (i.e., state of congestion) of a server in a server-client system if the access status is displayed at all the time in client terminal devices and the like, and this often causes the users not to pay attention to the access status in their displays. It is also thought that there is no need for the server to provide the access status to the users of the server when client terminal devices can make access to the server swiftly since the users generally have a little concern about display of the access status. However, the users often desire to know the access status data from the server when their access to the server becomes congested. On the other hand, if the server sends the access status data of it at all the time, it gives rise to a problem that the client terminal devices display the access status even when the users do not want it. There is also another problem that a space occupied for displaying the access status reduces an area of a monitor screen for other information and it prevents the client terminal devices from providing the users with pleasant working environment (i.e., display environment) if the access status of the server is displayed in the monitors and the like even when the users do not need it.

### SUMMARY OF THE INVENTION

The present invention was contrived to solve the above problems, and it was an object of this invention to provide a server and the like in a server client system that can output information on access status of the server when necessary.

In order to achieve the above object, the server of this invention comprises an execution processing unit for receiving access from a plurality of client terminal devices and executing processes in response to commands given by the client terminal devices, an acquiring unit for acquiring an access status data representing information showing access status of the client terminal devices in the execution processing unit, a determining unit for determining whether the access status data satisfies a predetermined condition, and an output unit for producing an output of data based on the access status data when the determining unit determines that the access status data satisfies the predetermined condition.

With the structure as described above, the output unit produces output of the data only when the access status data satisfies the predetermined condition. Accordingly, the server provides the data representing the access status and the like of the server only when the users need it by properly setting the predetermined condition, thereby avoiding the problem of sending the data when not required by the users. As a result, the server can provide the users, for instance, with pleasant working environment.

### BRIEF DESCRIPTION OF THE DRAWINGS

FIG. 1A is a schematic illustration showing an architecture of a server client system according to a first embodiment of the present invention;

FIG. 1B is a flowchart showing a principal process of the server client system according to the first embodiment of the invention;

FIG. 2 is a block diagram showing a structure of a server according to the first embodiment of the invention;

FIG. 3 is a flowchart showing operation of the server according to the first embodiment of the invention;

FIG. 4 is a table showing an example of log-in data according to the first embodiment of the invention;

FIG. 5 is a table showing an example of stored data on access status according to the first embodiment of the invention;

FIG. 6 is a schematic illustration showing an example of a client terminal device according to the first embodiment of the invention;

FIG. 7 is an illustration showing an example of display in the client terminal device according to the first embodiment of the invention;

FIG. 8 is an illustration showing an example of another display in the client terminal device according to the first embodiment of the invention;

FIG. 9 is a block diagram showing a structure of a server according to a second embodiment of the invention;

FIG. 10 is a flowchart showing operation of the server according to the second embodiment of the invention;

FIG. 11 is a table showing an example of log-in data according to the second embodiment of the invention;

FIG. 12 is an illustration showing an example of display in the client terminal device according to the second embodiment of the invention;

FIG. 13 is a block diagram showing a structure of a server according to a third embodiment of the invention;

FIG. 14 is a flowchart showing operation of the server according to the third embodiment of the invention;

FIG. 15 is a table showing an example of log-in data according to the third embodiment of the invention; and

FIG. 16 is an illustration showing an example of display in the client terminal device according to the third embodiment of the invention.

### DETAILED DESCRIPTION OF THE INVENTION

### FIRST EMBODIMENT

Referring now to the accompanying drawings, description is provided of a server according to the first embodiment of the present invention.

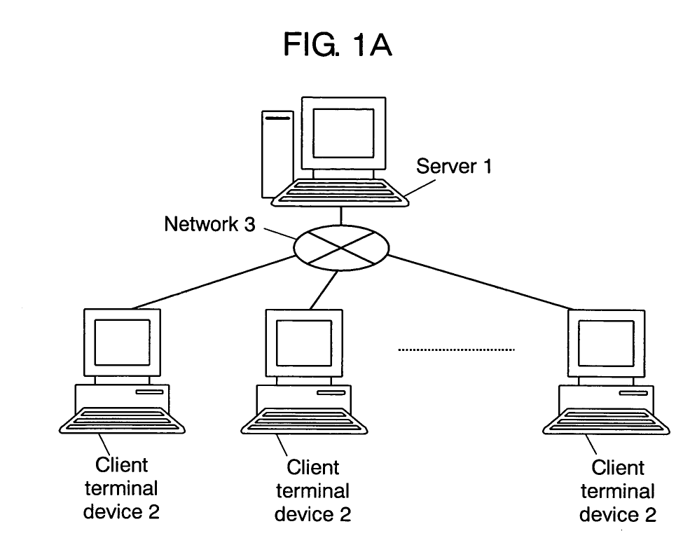

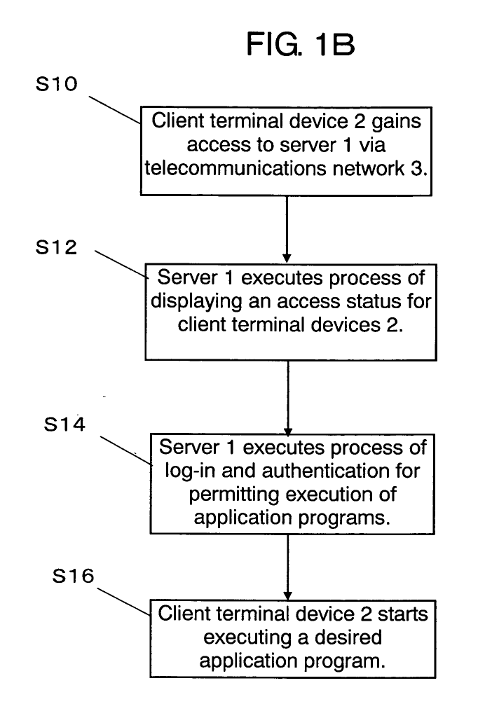

FIG. 1A is a schematic illustration showing an architecture of a server client system according to the first embodiment. In FIG. 1A, the server client system of the first embodiment comprises server 1 and a plurality of client terminal devices 2. Server 1 and these client terminal devices 2 are connected to telecommunications network 3 through any a cable and wireless connection. This telecommunications network may be the Internet, Intranet, and the like, for instance. The server client system in this first embodiment can be a server client system in the LAN, or it can be a system comprising a server such as a web server in the WAN of the Internet and the like and a data processor (i.e., the client terminal device) having a browser and the like for making access to the server.

FIG. 1B is a flowchart showing a principal process of the server client system according to the first embodiment of this invention.

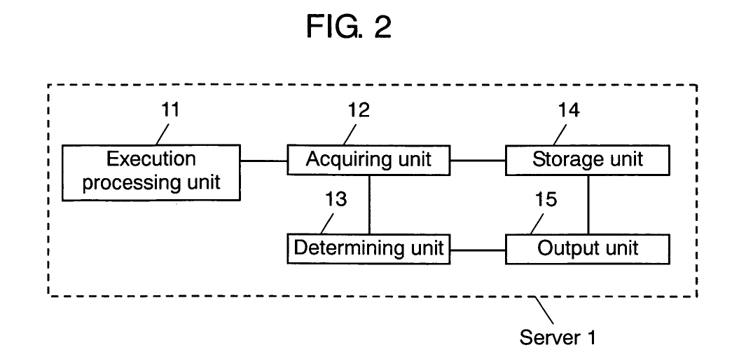

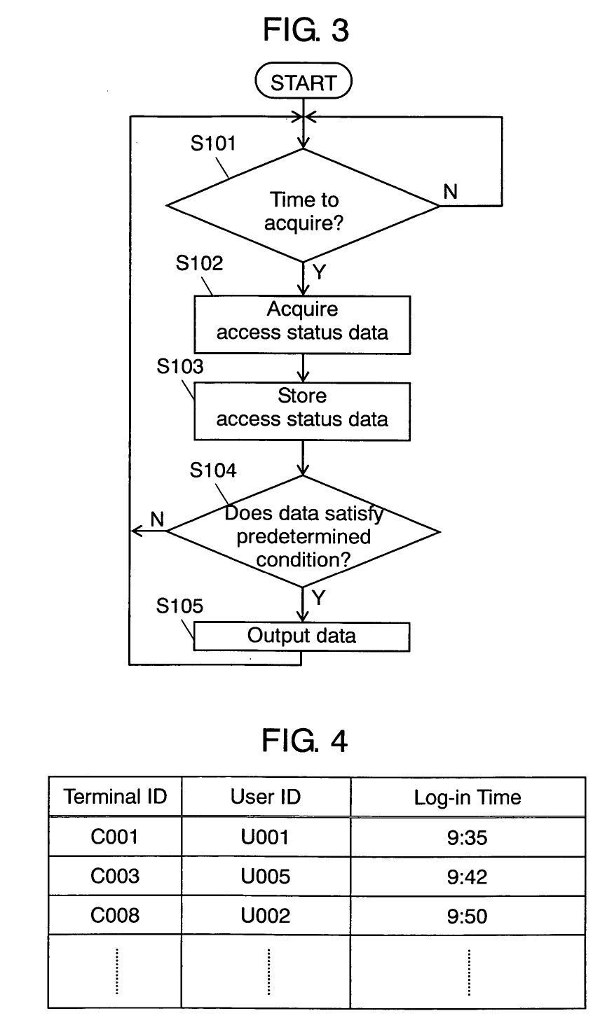

First, one of client terminal devices 2 gains access to server 1 via telecommunications network 3 (step S10). When being accessed, server 1 determines a status of access in the whole server client system, and executes a necessary process to provide display of the access status for client terminal devices 2 (step S12). Further details pertaining to the process of display will be provided later by referring to FIG. 2 and FIG. 3.

Subsequently, server 1 regulates a number of accesses it permits for client terminal devices 2 according to the access status (step S14). In other words, server 1 carries out a process of log-in and client authentication when it permits the access, or it does not carry out the process when it does not permit the access. The authentication process is carried out by execution processing unit 11, which will be discussed later. Therefore, a user of any of client terminal devices 2 can execute an application program only after permission of the access (step S16).

It should be understood that the steps S12 and S14 needs not be executed in this order. A result of the process in this system as a whole does not change even if, for instance, the step S14 is carried out prior to execution of the step S12.

As an unique feature of this invention, the process of displaying the access status is executed in the step S12 of the flowchart shown in FIG. 1B. This process of displaying the access status will be described hereinafter in more detail.

FIG. 2 is a block diagram showing a structure of server 1 according to the first embodiment. In FIG. 2, server 1 is provided with execution processing unit 11, acquiring unit 12, determining unit 13, storage unit 14, and output unit 15.

Execution processing unit 11 receives access from the plurality of client terminal devices 2, and executes data processing according to a command given by any of client terminal devices 2. This execution processing unit 11 comprises a CPU and storage means for storing a software program to be executed by the CPU, for instance. If server 1 is a database server, for example, execution processing unit 11 carries out transmission to client terminal device 2 of a retrieved result in response to a command of search and the like given by client terminal device 2.

Acquiring unit 12 acquires a data on access status. Here, the data on access status represents information that shows an access status of execution processing unit 11 by client terminal devices 2. A degree of congestion for carrying out data processing in execution processing unit 11 is thus shown by this data of access status. This data of access status includes, for example, information representing a number of client terminal devices 2 that remain logged in to server 1 (i.e., a number of users), information representing an operating rate of execution processing unit 11 (i.e., a ratio of processing load to a processing capacity of the CPU such as an average value of the utilization rate), and the like. Acquiring unit 12 may acquire the access status data by simply reading out a data stored in execution processing unit 11, or by making a predetermined process, arithmetical operation (e.g., counting a number of logged-in users), and the like based on the data kept in execution processing unit 11 (e.g., data representing users being logged in).

Determining unit 13 determines whether the latest access status data acquired by acquiring unit 12 satisfies a predetermined condition. Here, the predetermined condition is a condition in which the access status data indicates congestion beyond a predetermined threshold value. It is therefore known that execution processing unit 11 is in a state of handling the processing task exceeding a certain level when determining unit 13 determines that the access status data satisfies the predetermined condition. Although this predetermined condition, or the predetermined threshold value, can be set to any value, it is appropriate to set it to such a value that the access status data satisfies the predetermined condition when the users of client terminal devices 2 feel that it is getting slow to execute the process in response to commands provided by client terminal devices 2, for instance. A data representing this predetermined condition may be kept in advance in determining unit 13 or stored in a designated recording medium separate from determining unit 13, for example.

Storage unit 14 stores up the access status data acquired by acquiring unit 12 in a designated recording medium. This recording medium may be any of a semiconductor memory, an optical disk, a magnetic disk and the like, for instance, and it can be included in storage unit 14, or provided external of storage unit 14 (or, outside of server 1). In addition, the recording medium may be such a device that it stores the access status data temporarily, or it may do otherwise.

Output unit 15 produces an output of data when determining unit 13 determines that the latest access status data acquired by acquiring unit 12 satisfies the predetermined condition. This data output here is information based on the access status data stored in storage unit 14, and it represents a history of access status of execution processing unit 11. This output can be of any form such as display on a display device (e.g., a CRT, liquid crystal display, and the like), transmission to client terminal devices 2 via telecommunications network 3, printing by a printer, and audio output through a speaker. Output unit 15 may include an output device (e.g., a display device, printer, and the like), or it needs not include any device. Also, output unit 15 may be comprised of hardware, or software such as a driver for driving any the above devices. In the first embodiment, output unit 15 is illustrated as having the function of transmitting the output data to client terminal devices 2.

Server 1 according to the first embodiment operates in a manner which is described hereinafter by referring to a flowchart of FIG. 3. It is assumed here that execution processing unit 11 executes processing task according to commands provided by the plurality of clients terminal devices 2.

Step S101: Acquiring unit 12 determines whether it is a time to acquire an access status data. The process proceeds to step S102 when it determined to be the time to acquire the access status data, or it repeats the process of step S101 until it determines the time again to acquire the data. Here, the time for acquiring the access status data may be repeated at predetermined intervals (e.g., a period of every ten minutes), or it may be triggered by a predetermined event (e.g., log-in from new terminal device), or it may be any other timing.

Step S102: Acquiring unit 12 acquires an access status data.

Step S103: Storage unit 14 stores the access status data acquired by acquiring unit 12 in the step S102.

Step S104: Determining unit 13 determines whether the access status data acquired by acquiring unit 12 in the step S102, that is the latest access status data, satisfies the predetermined condition. Determining unit 13 transfers the result to output unit 15 and proceeds to step S105 if the access status data satisfies the predetermined condition, or the process returns to the step S101 if it does not satisfy.

Step S105: Output unit 15 produces an output of data containing information of the past access status data stored in storage unit 14. The process then returns to the step S101. The past access status data stored in storage unit 14 may also contain the latest access status data.

In the flowchart of FIG. 3, the process ends when the power is turned off or it is interrupted by a command of termination.

Using concrete examples, description is provided next of operation of server 1 according to the first embodiment. In the following concrete examples, it is assumed that access status data represents information showing a number of log-ins from client terminal devices 2 to server 1. It is also assumed that the predetermined condition is that a number of log-ins is equal to or larger than a predetermined threshold value (a number of “40” is used in the following concrete examples).

### FIRST CONCRETE EXAMPLE

In this first concrete example, description is provided of a case in which output unit 15 outputs a data to all client terminal devices 2 being logged-in, and execution processing unit 11 does not accept a new log-in when it determines that a number of log-ins exceeds the predetermined threshold value.

Execution processing unit 11 accepts log-ins from the plurality of client terminal devices 2 and executes processes in response to commands from the logged-in client terminal devices 2. FIG. 4 is a table showing an example of log-in data retained in execution processing unit 11. In FIG. 4, a terminal ID for identifying client terminal device 2 and a log-in time indicating the time a user has logged in are shown in a manner to correlate with a user ID that identifies the user. When the user logs out, execution processing unit 11 deletes the log-in data related to that user from the record.

It is assumed that acquiring unit 12 acquires a number of log-ins kept by client terminal devices 2 at intervals of 10 minutes. A data showing this number of log-ins is the access status data. More specifically, acquiring unit 12 acquires the access status data (i.e., the number of log-ins) by referring to the log-in data and counting the number of log-ins kept by client terminal devices 2 (i.e., counting a number of users, or the number of records included in the log-in data table).

Acquiring unit 12 determines at 10:00 AM of Dec. 15, 2003 that it is the acquiring time (step S101), and acquires a number of log-ins by referring to the log-in data table retained within execution processing unit 11 and counting the number of logged-in users (step S102). Assume here that the number of log-ins is “15”. Acquiring unit 12 passes on the acquired log-in number “15” to storage unit 14 and determining unit 13. Storage unit 14 stores the number of log-ins in relation to the time “10:00” (step S103). Determining unit 13 determines that the access status data does not satisfy the predetermined condition since the number of log-ins is less than 40 (step S104). As a result, output unit 15 does not produces an output of data.

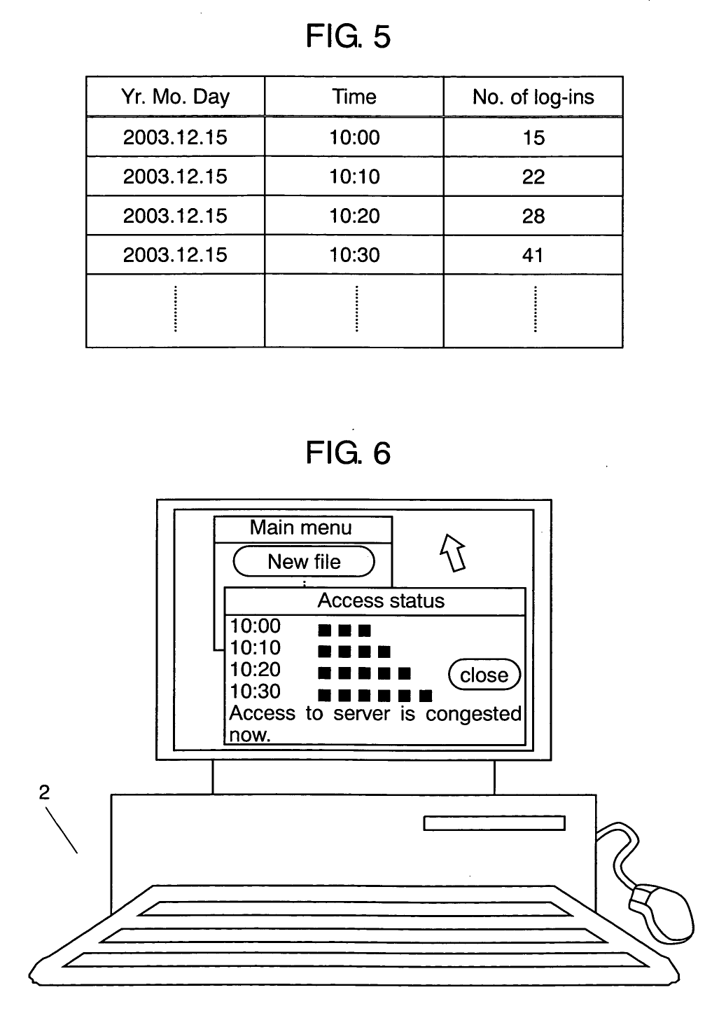

Storage unit 14 stores the access status data by repeating the above process. FIG. 5 is a table showing an example of the access status data stored in storage unit 14.

Assuming that the number of log-ins acquired by acquiring unit 12 at 10:30 AM is “41” (step S101 and S102). This log-in number “41” is stored in storage unit 14 (step S103). Determining unit 13 determines that it is larger than the threshold value of “40” (step S104). Determining unit 13 then sends its determination to output unit 15 that the number of log-ins exceeds the threshold value. In addition, determining unit 13 sends the same information that the number of log-ins exceeds the threshold value to execution processing unit 11 through a path, though not shown in the figure. As a result, output unit 15 reads out the access status data stored in storage unit 14, produces an output of data showing a past use history from the read access status data, and transmits the output data to the individual client terminal devices 2 being logged in (step S105). In the process here, output unit 15 transmits the output data to client terminal devices 2 being logged in by using terminal IDs obtained from execution processing unit 11 through a path, also not shown in the figure.

FIG. 6 is an illustration showing an example of display of the output data in client terminal device 2 while being logged in. As shown in FIG. 6, a history of congesting status is displayed in a window of the access status display according to the output data transmitted from server 1. In FIG. 6, the access status is graphically displayed. However, the access status may be displayed in numerical values or any other methods with no restriction.

According to the flowchart of FIG. 3, the output data is transmitted every time when the access status data is acquired if the latest access status data satisfies the predetermined condition. Each of client terminal devices 2 may be so programmed that it puts a completely new display whenever it receives a new output data, or it renews the display according to the new output data if it still shows the previous output data when the new output data is received.

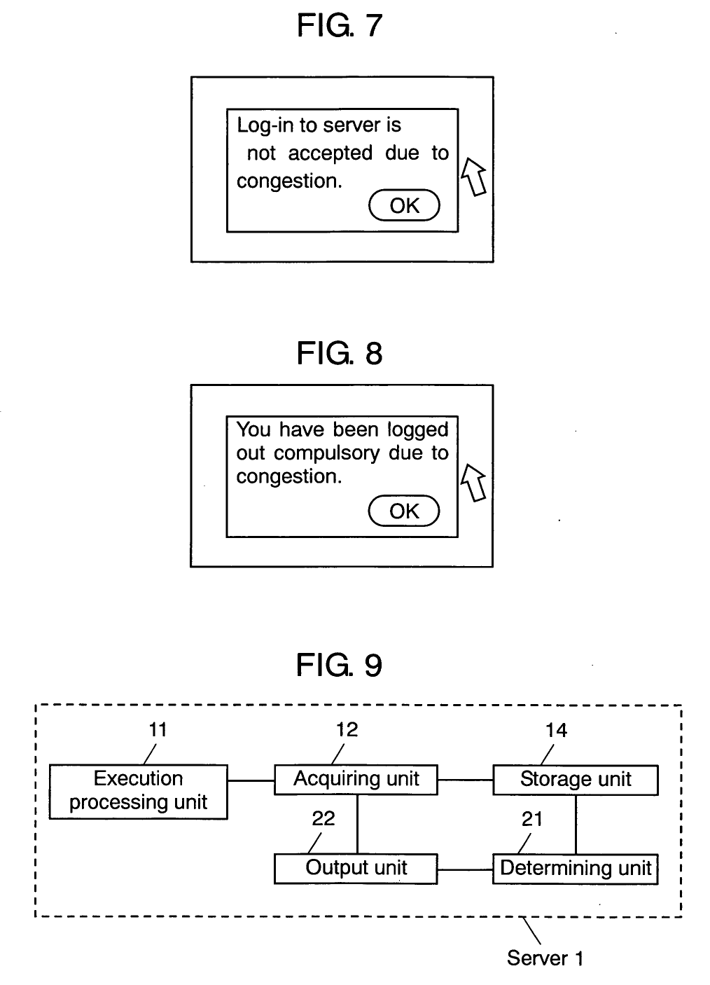

Execution processing unit 11 does not accept a new log-in after it receives a data from determining unit 13 indicating that the number of log-ins exceeds the predetermined threshold value “40”. In other words, execution processing unit 11 does not accept a new log-in even if it receives a command of log-in from any client terminal device 2, and it instead transmits to the client terminal device 2 information to the effect that the request of log-in is not accepted due to congestion. Accordingly, the client terminal device 2 displays a message shown in FIG. 7. In this instance, the information for display may include the output data, which output unit 15 transmits to the other client terminal devices 2 being logged in.

### SECOND CONCRETE EXAMPLE

In this second concrete example, description is provided of a case in which output unit 15 outputs a data to all client terminal devices 2 being logged in, and execution processing unit 11 logs out certain client terminal device 2 among the client terminal devices 2 kept logged in, when it determines that the number of log-ins exceeds the predetermined threshold value. Since operation up to the process of transmitting the output data from output unit 15 to client terminal devices 2 is analogous to the first concrete example, details of it is skipped.

Execution processing unit 11 refers to the log-in data, and logs out one of client terminal devices 2 that has logged in earliest when it receives information to the effect that the number of log-ins exceeds the predetermined threshold value of “40” from determining unit 13. This client terminal device 2 is the one identified by terminal ID “C001” in the log-in data table shown in FIG. 4.

To be more specific, execution processing unit 11 cancels the log-in of client terminal device 2 identified by terminal ID “C001”, and deletes the log-in data corresponding to the terminal ID “C001” from the record. Furthermore, execution processing unit 11 transmits to the compulsorily logged-out client terminal device 2, information to the effect that it has been logged out compulsorily. As a consequence, client terminal device 2 displays a message stating that it has been logged out compulsory, as shown in FIG. 8, and a user operating this client terminal device 2 knows of having been logged out compulsory.

This example can thus avoid the situation in that client terminal device 2 is logged out immediately after having logged in, by logging out another client terminal device 2 that has logged in earliest.

In this concrete example here, although what has been described is the case in that execution processing unit 11 makes logging-out unilaterally, execution processing unit 11 may transmit an instruction requesting immediate log out to the client terminal device 2 that has logged in earliest, for instance, to let the user of client terminal device 2 log out voluntarily in response to the transmitted request.

Moreover, although what has been described in this second concrete example is the case in that execution processing unit 11 first logs out client terminal device 2 having logged in earliest when the number of log-ins is determined larger than the predetermined threshold value, it may log out any other client terminal device 2. For instance, execution processing unit 11 may log out client terminal device 2 having a lightest workload, or another client terminal device 2 having a heaviest workload. In this case, execution processing unit 11 correlates information representing amount of workload to the individual terminal ID in the log-in data, for instance, and makes a selection of client terminal device 2 to be logged out by referring to the workload information. It is assumed that the workload included in the log-in data is updated according to new workload brought in by each client terminal device 2. The workload can be anything such as a value representing a cumulated amount of processing tasks imposed on execution processing unit 11, or another value showing an amount of processing at any given moment.

This example can substantially reduce the amount of workload on execution processing unit 11 by way of logging out client terminal device 2 of the heaviest workload in the above manner, thereby providing other client terminal devices 2 with pleasant working environment.

It is also fair to consider that client terminal device 2 of the lightest workload is not sending any command of processing task to execution processing unit 11, but it merely maintains log-in. It is thus thought to be free from any adverse effect to the user who is using such client terminal device 2 even if the client terminal device 2 is forced to log out. As a result, this example case can suppress the number of log-ins and a volume of information on log-in data, by the action of logging out client terminal devices 2 of the lightest workload while accepting new log-ins at the same time. Accordingly, this embodiment can avoid the situation in which the program and data are destroyed and the system becomes unstable due to an increase in the volume of information on log-in data, which results in over-recording the log-in data in excess of the anticipated memory area, and thereby this embodiment can provide the system with stable operation.

In the second concrete example, what has been described is the case in which execution processing unit 11 logs out one of client terminal devices 2 when it determines that the number of log-ins exceeds the predetermined threshold value. However, it may be appropriate to log out a plurality of the client terminal devices 2. The number of client terminal devices 2 to be logged out may be determined in advance, or it may as well be determined according to a number of log-ins at the time of making this determination (for instance, the number of devices to be logged out is increased if the number of log-ins exceeds well over the predetermined threshold value, or the number of devices to be logged out is decreased if otherwise)

In each of the above concrete examples, what has been described is the case in which output unit 15 transmits output data to the individual client terminal devices 2 being logged-in. However, output unit 15 may transmit the output data only to client terminal device 2 that has logged in latest. In this case, the latest log-in user learns through the output data that the user has been logged out even when response to processing is slow by execution processing unit 11.

According to the first embodiment, as described above, server 1 sends the output data based on the stored access status data when the latest access status data satisfies the predetermined condition, and it does not send the output data if otherwise. Server 1 can thus present the users of client terminal devices 2 using server 1 with the output data indicating the status of congestion whenever the latest access status data shows that the processing task of execution processing unit 11 is congested beyond the predetermined extent. As a result, server 1 provides its users with the access status data only when it is necessary, so as to avoid the users from being annoyed with the display of access status of server 1 when not needed.

In the first embodiment, although what has been described is the case that output unit 13 provides the output data including information on the past access status data stored in storage unit 14, it may be appropriate for output unit 13 to produce the output data including information on the latest access status data acquired by acquiring unit 12 at a time when the latest access status data is determined as satisfying the predetermined condition. Server 1 made to operate in the above manner can provide the output data from time to time when the execution processing unit is congested for processing. Also, server 1 is not required to have storage unit 14 in this case.

### SECOND EMBODIMENT

Referring to the accompanying drawings, description is provided of a server according to the second embodiment of the present invention. The server of this exemplary embodiment is designed to output a present access status data when a past access status data stored therein satisfies a predetermined condition. It should be assumed that an architecture of the server client system according to this embodiment is analogous to that shown in FIG. 1 in the first embodiment.

FIG. 9 is a block diagram showing a structure of server 1 according to the second embodiment. In FIG. 9, server 1 is provided with execution processing unit 11, acquiring unit 12, storage unit 14, determining unit 21, and output unit 22. The structure and operation of server 1, other than determining unit 21 and output unit 22, are analogous to those of the first embodiment, and their details are therefore skipped.

Determining unit 21 determines whether a past access status data stored in storage unit 14 satisfies a predetermined condition. To be more specific, determining unit 21 determines whether an access status data recorded at a same time as the present among the stored past access status data satisfies the predetermined condition. Here, the predetermined condition is same as that described in the first of embodiment. Furthermore, the same time means any of, for example, a time period or a time of day corresponding to the present time, a day of the week corresponding to the present day, a day of the month corresponding to the present day, a month corresponding to the present month, and the like.

Output unit 22 produces an output of data when determining unit 21 determines that the past access status data stored in storage unit 14 satisfies the predetermined condition. The output data here is information on the latest access status data acquired by acquiring unit 12. However, this output data may be information identical to the latest access status data, or other information generated from the latest access status data to represent a substance of it. An example of the latter case may be such that the latest access data is information shown by a numerical value to represent the latest access status data, and the output data is information showing the latest access data diagrammatically (e.g., shown by a graph and the like). This output can be of any form such as display on a display device (e.g., a CRT, liquid crystal display, and the like), transmission to client terminal device 2 via telecommunications networks 3, printing by a printer, and audio output through a speaker. Output unit 22 may include an output device (e.g., a display device, printer, and the like), or it needs not include any device. Also, output unit 22 may be comprised of hardware, or software such as a driver for driving any the above devices. In this second embodiment, output unit 22 is illustrated as having the function of transmitting the output data to client terminal devices 2.

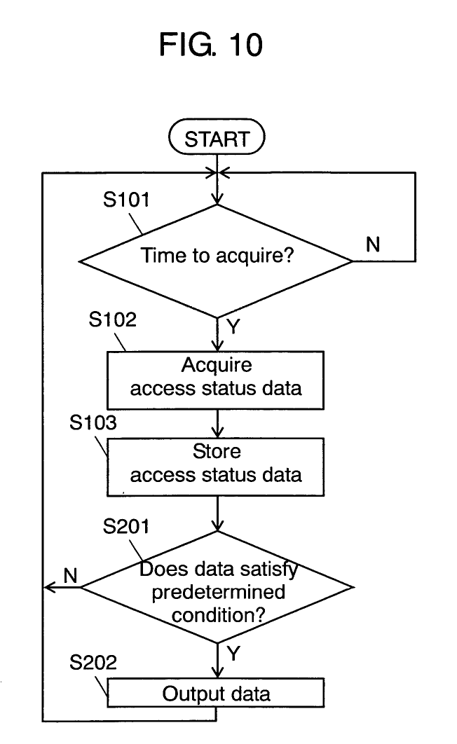

Server 1 according to the second embodiment operates in a manner which is described hereinafter by referring to a flowchart of FIG. 10. It is assumed here that execution processing unit 11 executes processing task according to commands provided by a plurality of clients terminal devices 2. Processes carried out in the steps other than step S201 and S202 are analogous to those of FIG. 3 in the first embodiment, and description of them will be skipped.

Step S201: Determining unit 21 determines whether the access status data stored in storage unit 14, or the past access status data, satisfies the predetermined condition. Determining unit 21 transfers the result to output unit 22 and proceeds to step S202 if the access status data satisfies the predetermined condition, or the process returns to the step S101 if it does not.

Step S202: Output unit 15 produces an output of data according to the access status data acquired by acquiring unit 12, and the process returns to the step

In the flowchart of FIG. 10, the process ends when the power is turned off or it is interrupted by a command of termination.

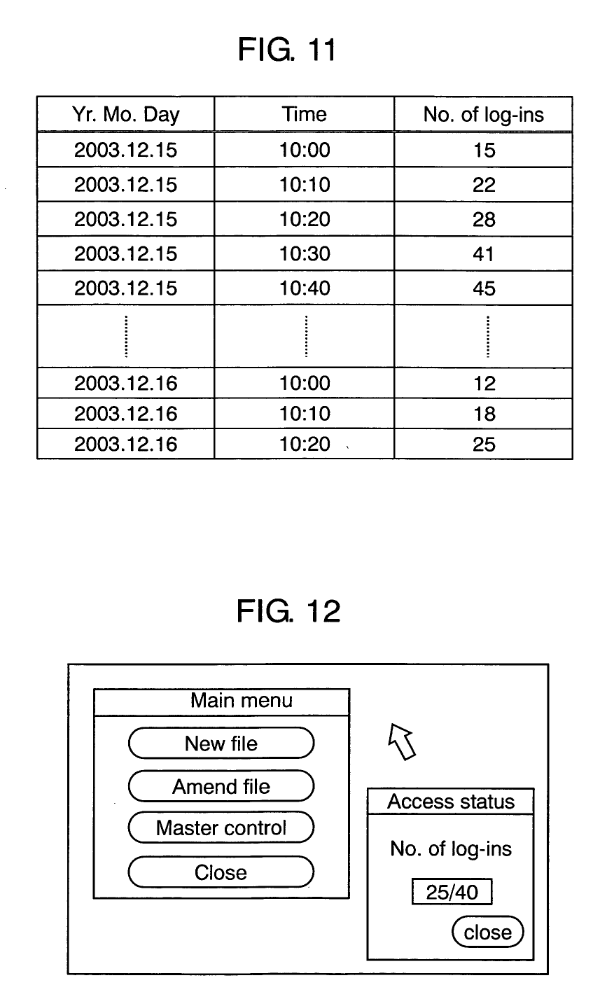

Using a concrete example, description is provided next of operation of server 1 according to the second embodiment. In the like manner as the concrete examples of the first embodiment, it is assumed in the following concrete example that the access status data represents information showing a number of log-ins from client terminal devices 2 to server 1. It is also assumed that the predetermined condition is that a number of log-ins during a same time period as the previous day is equal to or larger than a predetermined threshold value (a number of “40” is used in the following concrete example). It is further assumed that output unit 22 temporarily stores the latest access status data, or the access status data last acquired by acquiring unit 12 in a buffer memory (not shown) included in output unit 22. Since operation of server 1 up to the process of storing the access status data in storage unit 14 (steps S101 to S103) is analogous to the concrete examples in the first embodiment, details of it is skipped. FIG. 11 is a table showing one example of the access status data stored in this manner.

Assume that it is the 16^{th} day of Dec. 2003, and immediately after 10:20 when a number of log-ins “25” is stored. In no time, determining unit 21 determines whether a number of log-ins recorded at the same time period of the preceding day (i.e., Dec. 15, 2003) is equal to or larger than the threshold value “40” (the number of log-ins used here is that recorded in the day before, at a time corresponding to the succeeding sampling time) (steps S101 and S102). In other words, determining unit 21 determines that the number of log-ins “41” recorded at the time corresponding to 10:30 in Dec. 15, 2003 exceeds the threshold value “40”, and forwards information to that effect to output unit 22. Output unit 22 then transmits to all of client terminal devices 2 the present number of log-ins “25” stored in the buffer memory. In the consequence, “an access status”window shown in FIG. 12 is displayed in client terminal devices 2. In this display, the present number of log-ins and the threshold value are shown as the numerator and the denominator respectively. This display tells the users the present state of congestion.

In the concrete example of the second embodiment, the threshold value used is same as that of the concrete examples in the first embodiment. When the determination is made according to the past access status data, it may be appropriate to use a lower threshold value (“30” for instance) than that used for determination based on the latest access status data. Use of such a low value makes client terminal devices 2 display the access status data in a longer period of time than the previous period during which the server has been congested. This can be good measures to avoid any delay in transmitting the display even if there is a time lag in the present state of congestion as compared to the past state of congestion.

Moreover, the concrete example in the second embodiment has been illustrated to make the determination as to whether the number of log-ins in the same time period of the previous day is equal to or larger than the predetermined threshold value. The determination by determining unit 21 may be made according to the access status data of the same time period of the past, such as the same time period of the same day of the preceding month, and the same time period of the same day of the preceding week. Alternatively, the determination may also be made by using an average number of log-ins calculated from the access status data recorded in the past. For instance, the average number of log-ins can be calculated by using data recorded at the same time period during the previous one week, and used to determine if it is equal to or larger than the predetermined threshold value. Or, the average number of log-ins may be calculated for the entire hours of Monday, for instance, from the access status data recorded in the past, instead of a given time period, and transmit the output data to client terminal devices 2 for all day on Monday, if the average number of log-ins is equal to or larger than the predetermined threshold value.

In the concrete example of the second embodiment, output unit 22 has been illustrated as such that it produces the output data based on the access status data stored in the buffer memory included in it. Output unit 22 may instead produce the output of data based on the access status data last stored in storage unit 14.

Moreover, the server may be so designed that execution processing unit 11 does not accept a new log-in, or logs out certain client terminal device 2 in the like manner as the first embodiment, if the past access status data satisfies the predetermined condition.

Furthermore, output unit 22 may transmit the output data to all of client terminal devices 2 being logged-in, or it may transmit the output data only to one client terminal device 2 that has logged in latest.

According to the second embodiment as described above, server 1 sends the output data based on the latest access status data when the past access status data satisfies the predetermined condition, and it can thus present the log-in users with the present access status data when there is anticipation from the past access status data that the processing task of execution processing unit 11 will become congested beyond the predetermined extent. As a result, the access status data on display informs the users of the state of congestion that server 1 will become congested gradually even though it is not yet congested for the present, and the users viewing the display learns that response from server 1 will gradually become slow. Also, since the state of congestion of server 1 is displayed only for a certain period when such congestion is anticipated, so as to avoid the users from being annoyed with display of the access status of server 1 when not needed.

In the second embodiment, what has been described is the case that output unit 22 provides the output data including information on the latest access status data acquired by acquiring unit 12. However, it may be appropriate for output unit 22 to produce the output data including information on the past access status data stored in storage unit 14.

In the second embodiment, what has been described is the case that the determination is made as to whether the past access status data satisfies the predetermined condition by determining if the number of log-ins shown in the past access status data exceeds the predetermined threshold value. The past access status data may be determined to satisfy the predetermined condition, if, for instance, a number of log-ins anticipated in the future (e.g., 30 minutes later) obtained by extrapolating the past access status data exceeds the predetermined threshold value. In other words, “the past access status data” taken by determining unit 21 for the determination can be one of records of the access status data stored in storage unit 14, or the whole records of the access status data stored in storage unit 14 (which also includes the latest access status data).

### THIRD EMBODIMENT

Referring to the accompanying drawings, description is provided of a server according to the third embodiment of the present invention. The server of this third exemplary embodiment is designed to estimate, based on a stored access status data, a time by which an access status data becomes not satisfying at least a predetermined condition. It should be assumed that an architecture of the server client system according to this embodiment is also analogous to that of the first embodiment shown in FIG. 1.

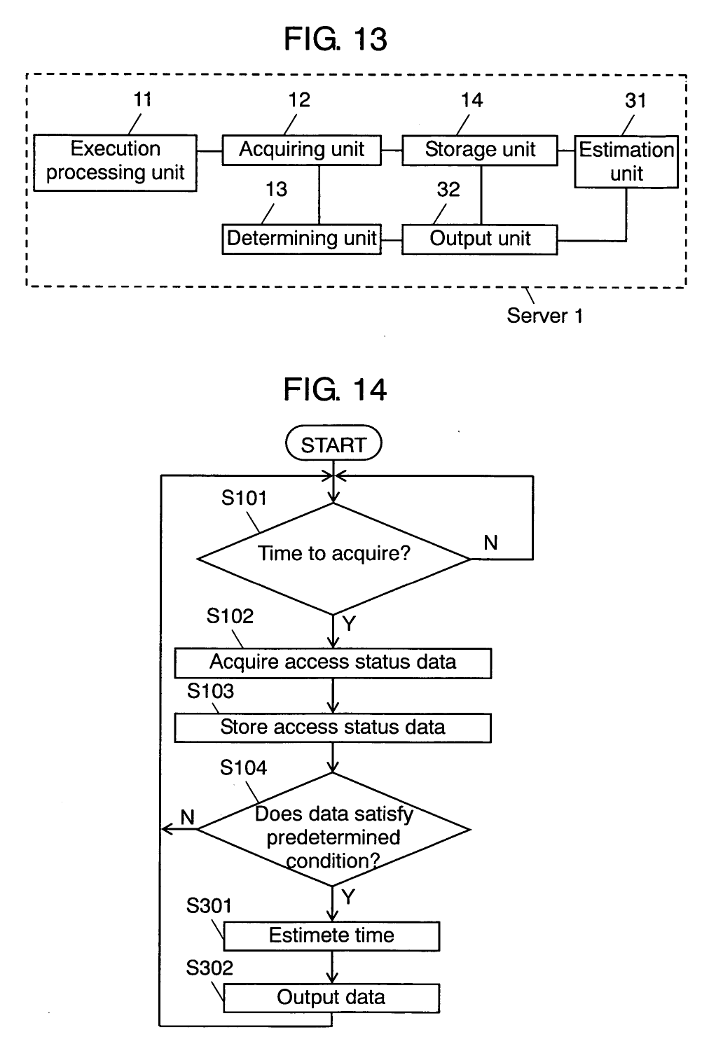

FIG. 13 is a block diagram showing a structure of server 1 according to the third embodiment. In FIG. 13, server 1 is provided with execution processing unit 11, acquiring unit 12, determining unit 13, storage unit 14, estimation unit 31, and output unit 32. The structure and operation of server 1, other than estimation unit 31 and output unit 32, are analogous to that of the first embodiment, and their details are therefore skipped.

Estimation unit 31 estimates a time when the access status data becomes not satisfying at least the predetermined condition, based on the access status data stored in storage unit 14. Here, this predetermined condition is the same condition as the predetermined condition used for determination by determining unit 13. The time when the access status data becomes not satisfying at least the predetermined condition means a time period that includes a part or all of a time period not satisfying the predetermined condition. The time to be estimated by estimation unit 31 may either be a closed period of time (e.g., between 2 o'clock and 3 o'clock) or an open period of time (e.g., from 2 o'clock). Or, the time may be a certain point of time of day. Or, the time may be any of an absolute time (e.g., between 2 o'clock and 3 o'clock of Dec. 16, 2003) and a relative time (e.g., from 1 hour later to 2 hours later).

Output unit 32 is similar to output unit 15 in the first embodiment, except that it provides an output of data including a time data indicating the time estimated by estimation unit 31.

Server 1 according to the third embodiment operates in a manner which is described hereinafter by referring to a flowchart of FIG. 14. It is assumed here that execution processing unit 11 executes processing task according to commands provided by a plurality of clients terminal devices 2. Processes carried out in the steps other than step S301 and S302 are analogous to those shown in FIG. 3 in the first embodiment, and description of them will be skipped.

Step S301: Estimation unit 31 estimates the time when the access status data becomes not satisfying at least the predetermined condition, based on the access status data stored in storage unit 14. Estimation unit 31 then passes on a time data representing the estimated time to output unit 32.

Step S302: Output unit 32 produces an output of data based on the access status data stored in storage unit 14. The output data includes the time data received from estimation unit 31. The process then returns to the step S101.

In the flowchart of FIG. 14, the process ends when the power is turned off or it is interrupted by a command of termination.

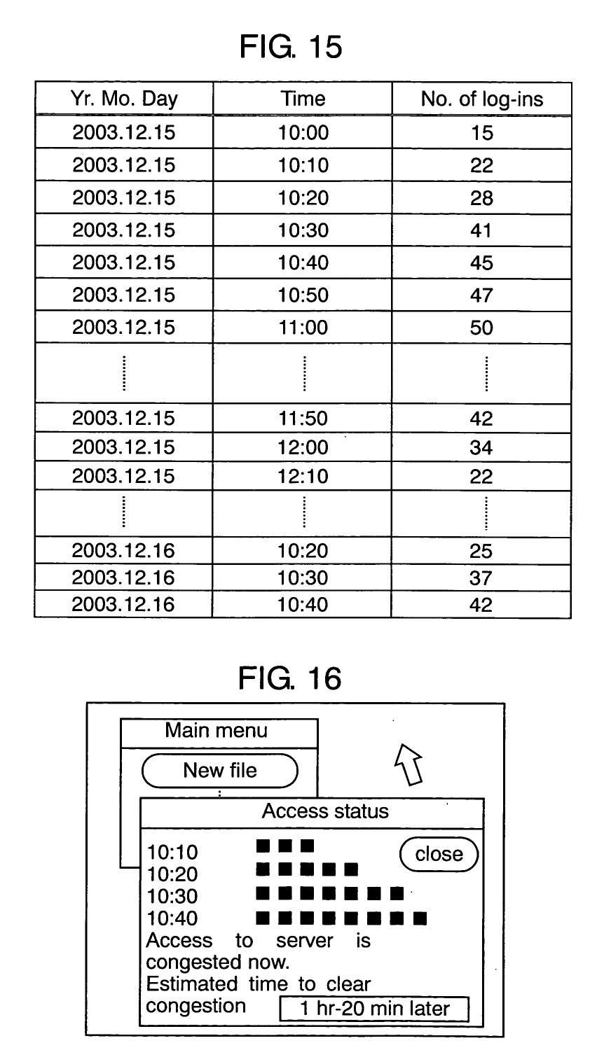

Using a concrete example, description is provided next of operation of server 1 according to the third embodiment. In the following concrete example, it is assumed that the access status data represents information showing a number of log-ins from client terminal devices 2 to server 1. It is also assumed that the predetermined condition is that a number of log-ins is equal to or larger than a predetermined threshold value (a number of “40” is used in the following concrete example). It is further assumed that estimation unit 31 estimates a time when the number of log-ins becomes less than “35”, as the time in which the number does not satisfy at least the predetermined condition. Operation of server 1 up to the process of storing the access status data in storage unit 14 and determining satisfaction to the predetermined condition (steps S101 to S104) is analogous to the concrete examples of the first embodiment, and the details of it is skipped. FIG. 15 is a table showing an example of the access status data stored in the above manner.

Assume that it is the 16th day of December, 2003, and immediately after 10:40 when a number of log-ins “42” is stored. In no time, determining unit 13 determines that this number of log-ins “42” satisfies the predetermined condition because it exceed the threshold value of “40” (step S104), and forwards information to that effect to output unit 32. Output unit 32 then passes on to estimation unit 31 the information that the latest access status data satisfies the predetermined condition. Subsequently, estimation unit 31 refers to numbers of log-ins taken during a similar time zone in the previous day (Dec. 15, 2003) among the access status data stored in storage unit 14, and obtains a recorded time, which shows less than 35 in the number of log-ins. Here, estimation unit 31 obtains 12:00 since the number of log-ins becomes less than 35 when the time reaches 12 o'clock in FIG. 15. Estimation unit 31 figures out a time difference (i.e., 1 hour and 20 minutes) between the obtained time (12 o'clock) and the present time (10:40), and passes on to output unit 32 a time data representing information of the time difference (step S301).

Output unit 32 reads out four records including the latest record out of the access status data stored in storage unit 14. Output unit 32 then generates an output of data containing the read access status data and the time data received from estimation unit 31, and transmits it to the individual client terminal devices 2 being logged in (step S302). As the consequence, information shown in FIG. 16 is displayed in the logged-in client terminal devices 2. The users operating client terminal devices 2 learn from this display that processing task in execution processing unit 11 is getting congested and there is a possibility that the congestion will become clear after a lapse of about 1 hour and 20 minutes. Since there are some users who would try to avoid the congested time to carry out their work with server 1, the display of information can help equalize the overall numbers of log-ins, and alleviate concentration of the processing task into certain periods of time and the problem of slowing down the responses to the commands.

In the third embodiment, what has been described is the example that estimation unit 31 makes estimation for the time of day. However, estimation unit 31 may be adapted to estimate other periods such as a day of week, date, and month, for example. Thus, the estimated information for less congested periods may be shown as “next Wednesday”, “18th day”, “January”, and the like.

In the concrete example of the third embodiment, the threshold value of “35” used in estimation unit 31 differs from the threshold value “40” in determining unit 13. The threshold value to be used in estimation unit 31 can be of any number as long as it is smaller than the threshold value used in determining unit 13. In this instance, estimation unit 31 makes estimation of time that satisfies a condition that “the number does not satisfy the predetermined condition used in determining unit 13”.

Moreover, the server may be so designed that it rejects a command of log-in, or logs out certain client terminal device 2 in the like manner as the concrete examples of the first embodiment, if the access status data satisfies the predetermined condition. Also, it may transmit the output data only to one client terminal device 2 that has logged in latest.

According to server 1 in the third embodiment, as described above, estimation unit 31 estimates a time when the processing task in execution processing unit 11 is not congested, and output unit 32 outputs a time data representing the estimated time, and thereby the users operating client terminal devices 2 know when the congestion is expected to clear away. As a result, this embodiment can help equalize the overall amount of processing task in the execution processing unit since some users handling not-so-urgent work would attempt to carry out the work when the server is not congested. In addition, the users can refer to the estimated time data and carry out the work during the time the server is free from congestion, thereby improving efficiency of the work.

Moreover, the estimation is made in estimation unit 31 by using the condition more stringent than the condition that “the number does not satisfy the predetermined condition used in determining unit 13”, as illustrated in the concrete example of this third embodiment. This enables estimation unit 31 to estimate not only the less congested time but also the time for the users to carry out their processing task more pleasantly in execution processing unit 11. This also provides a possibility of resolving any time lag between times of the estimated state of congestion and the actual state of congestion.

In the third embodiment, what has been described is the example that estimation unit 31 makes estimation of the time when the access status data does not satisfy at least the predetermined condition used in determining unit 13. However, estimation unit 31 may make estimation of the time when the access status data satisfies at least the predetermined condition used in determining unit 13. The time thus estimated indicates the time when the processing task in execution processing unit 11 is congested. Therefore, the users can use server 1 during other time periods by avoiding the congested time provided as estimated above.

In the third embodiment, although what has been described is an example in which estimation unit 31 is added to the structure of server 1 in the first embodiment, the estimation unit 31 is also addable to server 1 of the second embodiment.

Moreover, in the third embodiment, estimation unit 31 has been illustrated as making estimation in respect of the similarity between the past access status data and the present access status data. However, this method of estimation is merely an example, and estimation unit 31 may be designed to estimate a less congested time or a congested time by carrying out extrapolation to the stored access status data, for instance. To be more specific, estimation unit 31 can estimate a number of log-ins in the future by extrapolating the present number of log-ins, and make further estimation by comparing the estimated number of log-ins with the predetermined threshold value.

As described in each of the above exemplary embodiments, server 1 can be so composed that it has any one or a combination of the functions: (1) whether it performs estimation; (2) whether determining unit performs determination on the latest access status data or the past access status data; and (3) which one does the output data relate to, the past access status data or the latest access status data.

The output data can be information including both the latest access status data and the past access status data.

Because the server provides the users with records related to the congesting status of the past, the users are kept abreast of changes in the access status to the server, and able to estimate whether the congestion becomes heavier or is solved gradually in the future. In addition, since the server informs the users of the present status of access condition, the users can learn the present access status. Furthermore, the users can take measures such as temporary postponing their commands to server 1 for performing the task of processing.

In each of the above embodiments, although what has been described is the example in which the access status data represents the number of log-ins to server 1, the access status data needs not be limited to information showing the number of log-ins. Rather, it can be information representing an operating rate of execution processing unit 11.

Moreover, in each of the above embodiments, what has been described is the example in which the output data is transmitted to client terminal devices 2. The output data may instead be displayed in server 1. The display makes an administrator of server 1 known, when necessary, that the processing task in server 1 becomes congested.

Furthermore, in each of the above embodiments, the individual processes (or the individual functions) can be achieved by making the processes carried out centrally in a single device (or a system), or, by making them carried out separately with a plurality of devices. For example, server 1 transmits the access status data periodically to client terminal devices 2 so that each client terminal device 2 performs determination and the processes based on the transmitted access status data, and sends an output of data according to the result of determination. For another example, server 1 may be comprised of a database server and a web server, so that the database server acquires the access status data, and the web server sends an output of data.

In each of the above embodiments, individual structural components may be comprised of exclusive hardware, and functions of other components may be realized by executing program if attainable with software. A software program stored in a recording medium such as a hard disk, a semiconductor memory and the like, for instance, can be read and executed with a program execution device such as a CPU to achieve the function of the individual structural components. The software for achieving the data processing device according to each of the above embodiments can be a program as described hereinafter. In other words, the program dictates a computer to perform a function comprising the steps of acquiring an access status data representing information showing an access status of a plurality of client terminal devices being logged in to an execution processing unit, wherein the execution processing unit receives access by the client terminal devices and executes processes according to a command from any of the client terminal devices; determining whether the access status data satisfies a predetermined condition; and outputting a data based on the access status data when the access status data is determined as satisfying the predetermined condition.

In the above program, the step of outputting the data and the like do not include any processes that are executed by hardware (i.e., the tasks that can only be carried out with hardware) such as a modem and an interface card for making an output.

This program may be executed by being downloaded from the server and the like, or by being read out from any given recording medium (e.g., an optical disk such as CD-ROM, magnetic disk, semiconductor memory, and the like).

The computer for executing this program may comprise a single unit or plural units. That is, the program can be executed by means of central processing or distributed processing.

As described, the server and the like according to the present invention has a capability of outputting data on access status thereof in a server client system, and they are especially useful in the server client system in which the server executes processing according to a command from a client terminal.

1. A server comprising:
an execution processing unit for receiving access of a plurality of client terminal devices and executing processes according to a command given by the client terminal devices;
an acquiring unit for acquiring an access status data representing information showing access status of the client terminal devices in the execution processing unit;
a determining unit for determining whether the access status data satisfies a predetermined condition; and
an output unit for producing an output of data based on the access status data when the determining unit determines that the access status data satisfies the predetermined condition.

2. The server according to claim 1, wherein the determining unit determines whether a latest one of the access status data acquired by the acquiring unit satisfies the predetermined condition.

3. The server according to claim 1 further comprising:
a storage unit for storing the access status data acquired by the acquiring unit; and
an estimation unit for estimating one of a time when the access status data does not satisfy at least the predetermined condition, and another time when the access status data satisfy the predetermined condition, based on the access status data stored in the storage unit,
wherein the output data contains a time data representing information on the time estimated by the estimation unit.

4. The server according to claim 1 further comprising a storage unit for storing the access status data acquired by the acquiring unit,
wherein the determining unit determines whether any of the access status data stored in the past in the storage unit satisfies the predetermined condition.

5. The server according to claim 4, wherein the determining unit determines whether any of the access status data recorded at a same time as the present among the access status data of the past satisfies the predetermined condition.

6. The server according to claim 4 further comprising an estimation unit for estimating one of a time when the access status data does not satisfy at least the predetermined condition, and another time when the access status data satisfy the predetermined condition, based on the access status data stored in the storage unit,
wherein the output data contains a time data representing information on the time estimated by the estimation unit.

7. The server according to claim 1 further comprising a storage unit for storing the access status data acquired by the acquiring unit,
wherein the output data contains information on a past one of the access status data stored in the storage unit.

8. The server according to claim 3, wherein the output data contains information on a past one of the access status data stored in the storage unit.

9. The server according to claim 1, wherein the output data contains information on a latest one of the access status data stored in the storage unit.

10. The server according to claim 1, wherein the predetermined condition is to show that the access status data signifies congestion equal to or more than a predetermined threshold value.

11. The server according to claim 1, wherein the access status data acquired by the acquiring unit represents information showing a number of log-ins of the client terminal devices, and
the predetermined condition is that the number of log-ins is equal to or larger than a predetermined threshold value.

12. The server according to claim 11, wherein the output unit outputs the data to all of the client terminal devices being logged in.

13. The server according to claim 11, wherein the output unit outputs the data to one of the client terminal devices having logged in latest.

14. The server according to claim 11, wherein the execution processing unit does not accept a new log-in when the determining unit determines that the number of log-ins is equal to or larger than the predetermined threshold value.

15. The server according to claim 11, wherein the execution processing unit logs out a certain client terminal device among the client terminal devices being logged in when the determining unit determines that the number of log-ins is equal to or larger than the predetermined threshold value.

16. The server according to claim 15, wherein the certain client terminal device is one of the client terminal devices having logged in earliest.

17. The server according to claim 15, wherein the certain client terminal device is one of the client terminal devices having a lightest processing workload.

18. The server according to claim 15, wherein the certain client terminal device is one of the client terminal devices having a heaviest processing workload.

19. The server according to claim 1, wherein the access status data acquired by the acquiring unit represents information showing an operating rate of the execution processing unit, and
the predetermined condition is that the operating rate is equal to or larger than a predetermined threshold value.

20. A data processing system comprising:
a plurality of client terminal devices; and
a server as set forth in claim 1 for executing a processing task according to a command from any of the client terminal devices.

21. A method of data processing comprising the steps of:
acquiring an access status data representing information showing an access status of a plurality of client terminal devices being logged in to an execution processing unit, wherein the execution processing unit receives access by the client terminal devices and executes processes according to a command from any of the client terminal devices;
determining whether the access status data satisfies a predetermined condition; and
producing an output of data based on the access status data when the access status data is determined in the determining step as satisfying the predetermined condition.

22. A program for dictating a computer to perform a function comprising the steps of:
acquiring an access status data representing information showing an access status of a plurality of client terminal devices being logged in to an execution processing unit, wherein the execution processing unit receives access by the client terminal devices and executes processes according to a command from any of the client terminal devices;
determining whether the access status data satisfies a predetermined condition; and
producing an output of data based on the access status data when the access status data is determined in the determining step as satisfying the predetermined condition.

23. A recording medium having the program as set forth in claim 22.
